(19) United States
(12) Patent Application Publication
(10) Pub. No.: US 2022/0055606 A1
(43) Pub. Date: Feb. 24, 2022

(54) CONTROL DEVICE OF VEHICLE

(71) Applicant: HONDA MOTOR CO., LTD., Tokyo (JP)

(72) Inventors: Kaiwen TONG, Tokyo (JP); Nobuyuki ARUGA, Tokyo (JP); Masashi ETO, Tokyo (JP); Akio FUTATSUDERA, Tokyo (JP); Toshihiko FUKUDA, Tokyo (JP)

(73) Assignee: HONDA MOTOR CO., LTD., Tokyo (JP)

(21) Appl. No.: 17/404,527

(22) Filed: Aug. 17, 2021

(30) Foreign Application Priority Data
Aug. 21, 2020 (JP) 2020-139873

(51) Int. Cl. B60W 20/13; B60K 6/26; B60K 6/24; B60W 20/12

(52) U.S. Cl. CPC B60W 20/13; B60K 6/26; B60Y 2400/60; B60W 20/12; B60Y 2200/92; B60K 6/24

(57) ABSTRACT

A control device of a vehicle includes a discharge control unit configured to, in a case where a regenerative section is included in a scheduled traveling route of the vehicle, perform a discharge control for increasing a discharge amount of a power storage device as compared with a case where the regenerative section is not included in the scheduled traveling route. The discharge control unit is configured to determine a target discharge electric power amount, which is a target value to be discharged before the vehicle reaches a start point of the regenerative section, based on a predicted regenerative electric power amount that is capable of being generated in the regenerative section, and perform the discharge control based on the target discharge electric power amount and a parameter that changes in accordance with a distance from the vehicle to the start point.

### CROSS-REFERENCE TO RELATED APPLICATION

The present application claims priority from Japanese Patent Application No. 2020-139873 filed on Aug. 21, 2020, the entire content of which is incorporated herein by reference.

### TECHNICAL FIELD

The present invention relates to a control device of a vehicle.

### BACKGROUND ART

In recent years, a vehicle including an electric motor (motor generator) as a drive source of a vehicle and a power storage device (battery) that supplies electric power to the electric motor, such as a hybrid electrical vehicle, has been developed. Such a vehicle can charge the power storage device by supplying electric power regenerated by the electric motor to the power storage device in association with braking of the vehicle. In addition, such a vehicle is also configured to control charge and discharge of the power storage device based on a scheduled traveling route of the vehicle.

For example, Japanese Patent No. 6344429 discloses a technique in which, in a case where a downhill satisfying a predetermined condition is included in a scheduled traveling route of a vehicle, a remaining capacity of a storage battery is set to a first remaining capacity smaller than a standard remaining capacity. In addition, Japanese Patent No. 6436071 discloses a technique in which an SOC of a high-voltage battery in a scheduled traveling route is predicted based on a prediction result of a road gradient and a vehicle speed in the scheduled traveling route of a vehicle, and in a case where it is determined that the high-voltage battery is in a saturation state based on the predicted SOC, a discharge amount of the high-voltage battery is increased so as not to cause the high-voltage battery to be in the saturation state.

However, in the related art, there is a room for improvement from a viewpoint of appropriately controlling charge and discharge of a power storage device based on a scheduled traveling route of a vehicle. For example, in the related art, in a case where a distance from the vehicle to a regenerative section in which an electric motor can perform a regenerative operation is sufficiently long, that is, in a case where there is a sufficient possibility that the vehicle deviates from the scheduled traveling route including the regenerative section, the power storage device may be discharged based on the regenerative section may be performed. In such a case, even though the power storage device is discharged, regenerative electric power cannot be obtained by the vehicle deviating from the scheduled traveling route including the regenerative section, and a remaining capacity of the power storage device may be stagnant. Similarly, in the related art, even when a distance from the vehicle to a discharge section in which the electric power of the power storage device is supplied to the electric motor is sufficiently long, the power storage device is charged based on the discharge section, and there is a possibility that the vehicle deviates from the scheduled traveling route including the discharge section (that is, the charge of the power storage device becomes wasted) even though the power storage device is charged.

### SUMMARY OF INVENTION

The present invention provides a control device of a vehicle capable of appropriately controlling charge and discharge of a power storage device based on a scheduled traveling route of a vehicle.

According to an aspect of the present invention, there is provided a control device of a vehicle. The vehicle includes a power storage device, and an electric motor connected to a drive wheel, driven by being supplied with electric power of the power storage device, and configured to supply regenerative electric power generated by a regenerative operation to the power storage device. The control device includes a discharge control unit configured to, in a case where a regenerative section in which the electric motor is able to perform a regenerative operation is included in a scheduled traveling route of the vehicle, perform a discharge control for increasing a discharge amount of the power storage device as compared with a case where the regenerative section is not included in the scheduled traveling route. The discharge control unit is configured to determine a target discharge electric power amount, which is a target value to be discharged before the vehicle reaches a start point of the regenerative section, based on a predicted regenerative electric power amount that is capable of being generated in the regenerative section, and perform the discharge control based on the target discharge electric power amount and a parameter that changes in accordance with a distance from the vehicle to the start point.

According to another aspect of the present invention, there is provided a control device of a vehicle. The vehicle includes a power storage device, an electric motor connected to a drive wheel and driven by being supplied with electric power of the power storage device, and a generator configured to generate electric power and supplying the generated electric power to the power storage device. The control device includes a charge control unit configured to, in a case where a discharge segment in which the electric power of the power storage device is supplied to the electric motor is included in a scheduled traveling route of the vehicle, perform a charge control for increasing a charge amount of the power storage device as compared with a case where the discharge section is not included in the scheduled traveling route. The charge control unit is configured to determine a target charge electric power amount, which is a target value to be charged before the vehicle reaches a start point of the discharge section based on a predicted discharge electric power amount that is capable of being discharged in the discharge section, and perform the charge control based on the target charge electric power amount and a parameter that changes in accordance with a distance from the vehicle to the start point.

According to the present invention, it is possible to appropriately control the charge and discharge of the power storage device based on the scheduled traveling route of the vehicle.

### BRIEF DESCRIPTION OF DRAWINGS

FIG. 1 is a diagram showing a schematic configuration of a vehicle according to an embodiment.

FIG. 2 is a diagram showing an example of a target discharge electric power amount.

FIG. 3 is a diagram showing an example of discharge of a battery by a discharge control.

FIG. 4 is a flowchart showing an example of a discharge control process.

FIG. 5 is a diagram showing a specific example in a case where the discharge control is performed.

FIG. 6 is a diagram showing a specific example in a case where a charge control is performed.

### DESCRIPTION OF EMBODIMENTS

Hereinafter, an embodiment of a control device of a vehicle according to the present invention will be described in detail with reference to the drawings.

[Vehicle]

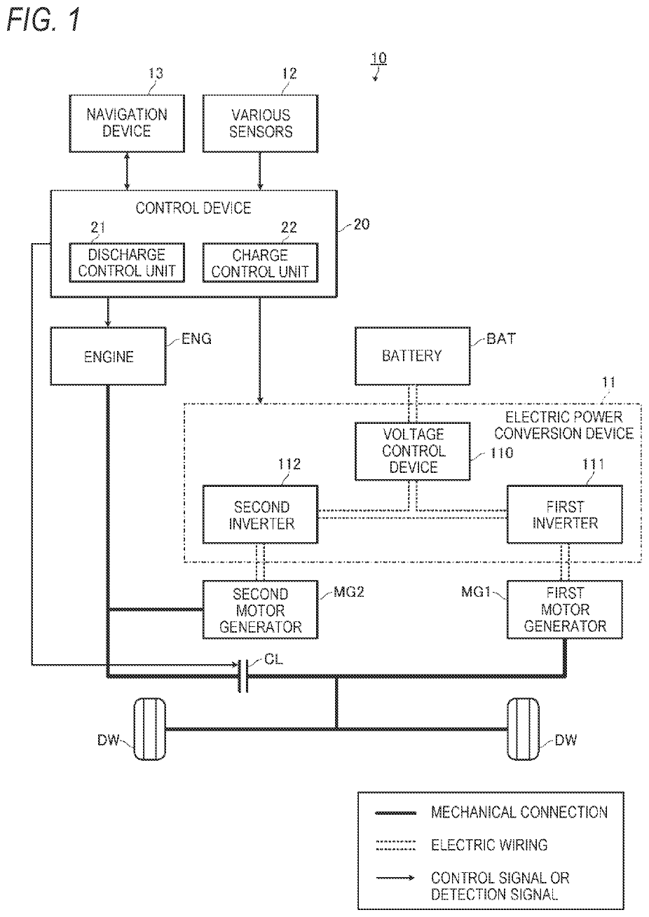

As shown in FIG. 1, a vehicle 10, which is an example of a vehicle according to the present invention, is a hybrid electrical vehicle, and includes an engine ENG, a first motor generator MG1, a second motor generator MG2, a battery BAT, a clutch CL, an electric power conversion device 11, various sensors 12, a navigation device 13, and a control device 20. In FIG. 1, thick solid lines each indicate a mechanical connection, double dotted lines each indicate an electric wiring, and thin solid line arrows each indicate a control signal or a detection signal.

The engine ENG is, for example, a gasoline engine or a diesel engine, and outputs power generated by burning supplied fuel. The engine ENG is coupled to the second motor generator MG2 and also coupled to drive wheels DW of the vehicle 10 via the clutch CL. Therefore, the power output by the engine ENG (hereinafter, also referred to as “output of the engine ENG”) is transmitted to the second motor generator MG2 in a case where the clutch CL is in a disconnected state, and is transmitted to the second motor generator MG2 and the drive wheels DW in a case where the clutch CL is in a connected state (engaged state). The second motor generator MG2 and the clutch CL will be described later.

The first motor generator MG1 is, for example, an alternating current motor, and is a motor generator (so-called driving motor) mainly used as a drive source of the vehicle 10. The first motor generator MG1 is driven by being supplied with electric power, and outputs power corresponding to the electric power. In addition, the first motor generator MG1 is coupled to the drive wheels DW, and the power output from the first motor generator MG1 (hereinafter, also referred to as “output of the first motor generator MG1”) is transmitted to the drive wheels DW. The vehicle 10 travels by transmitting (that is, supplying) at least one of the output of the engine ENG and the output of the first motor generator MG1 described above to the drive wheels DW.

The first motor generator MG1 is electrically connected to the battery BAT and the second motor generator MG2 via the electric power conversion device 11 to be described later, and the first motor generator MG1 can be supplied with electric power from at least one of the battery BAT and the second motor generator MG2. Although details will be described later, the battery BAT is a rechargeable and dischargeable secondary battery, and the second motor generator MG2 is a motor generator mainly used as a generator.

The first motor generator MG1 performs a regenerative operation during braking of the vehicle 10 to generate electric power (so-called regenerative power generation). Electric power generated by the regenerative operation of the first motor generator MG1 (hereinafter, also referred to as “regenerative electric power”) can be supplied to the battery BAT via the electric power conversion device 11. By supplying the regenerative electric power to the battery BAT, the battery BAT can be charged with the regenerative electric power.

The regenerative electric power may be supplied to the second motor generator MG2 via the electric power conversion device 11. By supplying the regenerative electric power to the second motor generator MG2, it is possible to perform “waste electricity” in which the regenerative electric power is consumed without being supplied to the battery BAT.

Specifically, in the vehicle 10, in a case where a state of charge (SOC) of the battery BAT becomes equal to or greater than a waste electricity start SOC, the control device 20 to be described later controls the regenerative electric power so that the regenerative electric power is supplied to the second motor generator MG2 (that is, so that the waste electricity is performed). In other words, in a case where the SOC of the battery BAT is less than the waste electricity start SOC, the control device 20 controls the regenerative electric power so that the regenerative electric power is supplied to the battery BAT (that is, so that the battery BAT is charged by the regenerative electric power).

Here, the waste electricity start SOC is a predetermined threshold value as a condition for performing (starting) the waste electricity, and is set to a value (for example, 90 [%]) smaller than 100 [%], which is an SOC at the time of full charge. Accordingly, it is possible to suppress the battery BAT from being overcharged by the regenerative electric power, and therefore it is possible to suppress deterioration of the battery BAT due to an overcharged state.

At the time of waste electricity, the regenerative electric power supplied to the second motor generator MG2 is used for driving the second motor generator MG2, and the generated power is input to the engine ENG to be consumed by mechanical friction loss of the engine ENG and the like. As a specific technique for performing such waste electricity, techniques described in Japanese Patent No. 6344429 and Japanese Patent No. 6531130 can be used. A control performed by the control device 20 for performing such waste electricity is hereinafter also referred to as a “waste electricity control”.

The second motor generator MG2 is, for example, an alternating current motor, and is a motor generator (so-called power generation motor) mainly used as a generator as described above. The second motor generator MG2 is driven by the power of the engine ENG to generate electric power. The electric power generated by the second motor generator MG2 is supplied to at least one of the battery BAT and the first motor generator MG1 via the electric power conversion device 11. By supplying the electric power generated by the second motor generator MG2 to the battery BAT, the battery BAT can be charged with the electric power. In addition, by supplying the electric power generated by the second motor generator MG2 to the first motor generator MG1, the first motor generator MG1 can be driven by the electric power.

The electric power conversion device 11 is a device (so-called power control unit, also referred to as “PCU”) that is connected to the first motor generator MG1, the second motor generator MG2, and the battery BAT, converts an input electric power, and outputs the converted electric power. Specifically, the electric power conversion device 11 includes a first inverter 111, a second inverter 112, and a voltage control device 110. The first inverter 111, the second inverter 112, and the voltage control device 110 are electrically connected to each other.

The voltage control device 110 converts an input voltage and outputs the converted voltage. A DC/DC converter or the like can be used as the voltage control device 110. For example, in a case where the electric power of the battery BAT is supplied to the first motor generator MG1, the voltage control device 110 boosts an output voltage of the battery BAT to output the electric power to the first inverter 111. In addition, in a case where the regenerative power generation is performed by the first motor generator MG1, the voltage control device 110 steps down an output voltage of the first motor generator MG1 received. via the first inverter 111 to output the electric power to the battery BAT. Further, in a case where electric power is generated by the second motor generator MG2, the voltage control device 110 steps down an output voltage of the second motor generator MG2 received via the second inverter 112 to output the electric power to the battery BAT.

In the case where the electric power of the battery BAT is supplied to the first motor generator MG1, the first inverter 111 converts the electric power (direct current) of the battery BAT received via the voltage control device 110 into an alternating current and outputs the alternating current to the first motor generator MG1. In addition, in the case where the first motor generator MG1 performs the regenerative power generation, the first inverter 111 converts the electric power (alternating current) received from the first motor generator MG1 to a direct current and outputs the direct current to the voltage control device 110. In a case where the above-described waste electricity control is performed, the first inverter 111 converts the electric power (alternating current) received from the first motor generator MG1 to a direct current and outputs the direct current to the second inverter 112.

In the case where the electric power is generated by the second motor generator MG2, the second inverter 112 converts the electric power (alternating current) received from the second motor generator MG2 into a direct current and outputs the direct current to the voltage control device 110. In addition, in the case where the above-described waste electricity control is performed, the second inverter 112 converts the regenerative electric power (direct current) of the first motor generator MG1 received via the first inverter 111 into an alternating current and outputs the alternating current to the second motor generator MG2.

The battery BAT includes a plurality of power storage cells connected in series or series-parallel, and is configured to output a high voltage of, for example, 100 [V] to 400 [V]. As the power storage cell of the battery BAT, a lithium ion battery, a nickel hydrogen battery, or the like can be used.

The clutch CL can take the connected state in which a power transmission path from the engine ENG to the drive wheel DW is connected (engaged), and the disconnected state in which the power transmission path from the engine ENG to the drive wheel DW is disconnected (blocked). The output of the engine ENG is transmitted to the drive wheel DW only when the clutch CL is in the connected state, and is not transmitted to the drive wheel DW when the clutch CL is in the disconnected state.

The various sensors 12 include, for example, a vehicle speed sensor that detects a speed of the vehicle 10 (hereinafter, also referred to as a “vehicle speed”), an accelerator position (hereinafter, also referred to as an “AP”) sensor that detects an operation amount of the vehicle 10 with respect to an accelerator pedal, and a battery sensor that detects various types of information on the battery BAT (for example, the output voltage of the battery BAT, a charge and discharge current, and a temperature). Detection results of the various sensors 12 are sent to the control device 20 as detection signals.

The navigation device 13 includes a storage device (for example, a flash memory) that stores map data and the like, a global navigation satellite system (GNSS) receiver that can specify a position of the vehicle 10 (hereinafter also referred to as a “host vehicle position”) based on a signal received from a positioning satellite, a display that displays various types of information, an operation button (including a touch panel) that receives an operation from a user (for example, a driver) of the vehicle 10, and the like.

The map data stored in the navigation device 13 includes road data related to a road. In the road data, each road is divided for predetermined sections, and the road data includes information on links corresponding to the respective sections and nodes connecting the links. In addition, in the road data, attribute information indicating a regulated speed (for example, a legal speech or a gradient of a section corresponding to the link is provided in association with each link.

The navigation device 13 determines, for example, a route from the host vehicle position to a destination set by the user of the vehicle 10 (hereinafter referred to as a “guidance route”) with reference to the map data or the like, and displays the determined guidance route on the display to guide the user.

The navigation device 13 predicts the scheduled traveling route of the vehicle 10 with reference to the host vehicle position, a traveling direction of the vehicle 10, the set destination, the map data, and the like. As an example, the navigation device 13 predicts a section (for example, a section from the host vehicle position to 10 [km] ahead in the traveling direction) within a predetermined range ahead of (that is, in front of) the traveling direction of the vehicle 10 from the host vehicle position as the scheduled traveling route.

When the scheduled traveling route is predicted, the navigation device 13 transmits route information on the scheduled traveling route to the control device 20. The route information includes information indicating each section included in the scheduled traveling route and the attribute information of each section. Accordingly, the navigation device 13 can notify the control device 20 of each section included in the scheduled traveling route and the regulated speed, the gradient and the like of the section. In addition, the navigation device 13 also notifies the control device 20 of the host vehicle position as appropriate.

The navigation device 13 may be configured to receive road traffic information including congestion information, and may transmit the received road traffic information to the control device 20. In this way, the navigation device 13 can notify the control device 20 of a congestion situation or the like of the scheduled traveling route.

The control device 20 is an example of the control device of a vehicle of the present invention, is provided in a state of being able to communicate with the engine ENG, the clutch CL, the electric power conversion device 11, the various sensors 12, and the navigation device 13. The control device 20 controls the output of the engine ENG, controls the outputs of the first motor generator MG1 and the second motor generator MG2 by controlling the electric power conversion device 11, and controls the state of the clutch CL. Accordingly, as will be described later, the control device 20 can control a traveling mode of the vehicle 10, perform a discharge control, and perform a charge control. In addition, the control device 20 can also perform the waste electricity control as described above.

The control device 20 can be realized by, for example, an electronic control unit (ECU) including a processor that performs various calculations, a storage device that stores various types of information, an input/output device that controls input and output of data between the inside and the outside of the control device 20, and the like. The control device 20 may be realized by one ECU, or may be realized by a plurality of ECUs.

[Traveling Mode of Vehicle]

Next, the traveling mode of the vehicle 10 will be described. The vehicle 10 can take an EV traveling mode, a hybrid traveling mode, and an engine traveling mode as the traveling modes. Further, the vehicle 10 travels in any one of the traveling modes. Which traveling mode the vehicle 10 is driven in is controlled by the control device 20.

[EV Traveling Mode]

The EV traveling mode is a traveling mode in which only the electric power of the battery BAT is supplied to the first motor generator MG1 and the vehicle 10 is driven by the power output from the first motor generator MG1 in accordance with the electric power.

Specifically, in a case of the EV traveling mode, the control device 20 brings the clutch CL into the disconnected state. In addition, in the case of the EV traveling mode, the control device 20 stops the supply of the fuel to the engine ENG (performs so-called fuel cut), and stops the output of the power from the engine ENG. That is, in the EV traveling mode, power generation by the second motor generator MG2 is not performed. In the case of the EV traveling mode, the control device 20 performs a control so that only the electric power of the battery BAT is supplied to the first motor generator MG1, and the first motor generator MG1 outputs power corresponding to the electric power to drive the vehicle 10 by the power.

Even when only the electric power of the battery BAT is supplied to the first motor generator MG1, the control device 20 perform a control so that the vehicle 10 travels in the EV traveling mode on a condition that a driving force (so-called required driving force) required for the traveling of the vehicle 10 can be obtained as the power output by the first motor generator MG1 in accordance with the electric power.

In the EV traveling mode, since the supply of the fuel to the engine ENG is stopped, the fuel consumed by the engine ENG is reduced and a fuel efficiency of the vehicle 10 is improved as compared with the other traveling modes in which the fuel is supplied to the engine ENG. Therefore, it is possible to improve the fuel efficiency of the vehicle 10 by increasing a frequency (opportunity) of setting the vehicle 10 in the EV traveling mode.

In the EV traveling mode, since the second motor generator MG2 does not generate electric power, and the first motor generator MG1 is driven only by the electric power of the battery BAT, the SOC of the battery BAT tends to decrease. In other words, when the vehicle 10 travels in the EV traveling mode, the battery BAT can be quickly discharged as compared with a case where the vehicle 10 travels in another traveling mode.

[Hybrid Traveling Mode]

The hybrid traveling mode is a traveling mode in which at least the electric power of the second motor generator MG2 is supplied to the first motor generator MG1, and the vehicle 10 is mainly driven by the power output by the first motor generator MG1 in accordance with the electric power.

Specifically, in a case of the hybrid traveling mode, the control device 20 brings the clutch CL into the disconnected state. In addition, in the case of the hybrid traveling mode, the control device 20 performs a control so that the fuel is supplied to the engine ENG, and the engine ENG outputs the power to drive the second motor generator MG2 by the power of the engine ENG. Accordingly, in the hybrid traveling mode, the electric power is generated by the second motor generator MG2.

In the case of the hybrid traveling mode, the control device 20 performs a control so that the electric power generated by the second motor generator MG2 is supplied to the first motor generator MG1, and the first motor generator MG1 outputs power corresponding to the electric power. The electric power supplied from the second motor generator MG2 to the first motor generator MG1 is larger than the electric power supplied from the battery BAT to the first motor generator MG1. Therefore, in the hybrid traveling mode, as compared with the EV traveling mode, the output of the first motor generator MG1 can be increased, and a large driving force can be obtained as a driving force for causing the vehicle 10 to travel (hereinafter, also referred to as “output of the vehicle 10”).

In the case of the hybrid traveling mode, the control device 20 may also cause the electric power of the battery BAT to be supplied to the first motor generator MG1 as necessary. That is, in the hybrid traveling mode, the control device 20 may cause both the electric power of the second motor generator MG2 and the electric power of the battery BAT to be supplied to the first motor generator MG1. Accordingly, as compared with the case where only the electric power of the second motor generator MG2 is supplied to the first motor generator MG1, the electric power supplied to the first motor generator MG1 can be increased, and a larger driving force can be obtained as the output of the vehicle 10.

[Engine Traveling Mode]

The engine traveling mode is a traveling mode in which the vehicle 10 is mainly driven by the power output from the engine ENG.

Specifically, in a case of the engine traveling mode, the control device 20 brings the clutch CL into the connected state. In the case of the engine traveling mode, the control device 20 performs a control so that the fuel is supplied to the engine ENG, and the power is output from the engine ENG. In the case of the engine traveling mode, since the clutch CL is in the connected state, the power of the engine ENG is transmitted to the drive wheels DW to drive the drive wheels DW. As a result, the vehicle 10 travels.

In the case of the engine traveling mode, the control device 20 may also cause the electric power of the battery BAT to be supplied to the first motor generator MG1 as necessary. Accordingly, in the engine traveling mode, the vehicle 10 can be driven using the power output from the first motor generator MG1 by the supply of the electric power of the battery BAT, and a larger driving force can be obtained as the output of the vehicle 10 as compared with the case where the vehicle 10 is driven only by the power of the engine ENG. As a result, the output of the engine ENG can be suppressed and the fuel efficiency of the vehicle 10 can be improved as compared with the case where the vehicle 10 is driven only by the power of the engine ENG.

[Control Device]

Next, the control device 20 will be described. As shown in FIG. 1, the control device 20 includes a discharge control unit 21 as a functional unit realized by a processor executing a program stored in a storage device of the control device 20.

In a case where the scheduled traveling route of the vehicle 10 includes the regenerative section in which the first motor generator MG1 can perform the regenerative operation, the discharge control unit 21 is configured to perform the discharge control of discharging the battery BAT before the vehicle 10 reaches a start point of the regenerative section based on the remaining capacity of the battery BAT and a predicted regenerative electric power amount in the regenerative section. Here, the regenerative section is, for example, a downhill where an altitude at an end point, which is an end on a side farther from the vehicle 10, is lower than an altitude at a start point, which is an end on a side close to the vehicle 10.

In the discharge control, when the vehicle 10 is traveling in the hybrid traveling mode or the engine traveling mode, the discharge control unit 21 decreases the output of the engine ENG, and increases the output of the first motor generator MG1 by increasing the electric power supplied from the battery BAT to the first motor generator MG1. By performing such discharge control, the fuel efficiency of the vehicle 10 can be improved by reducing the fuel consumed by the engine ENG while suppressing a decrease in the output of the vehicle 10.

It is preferable that the discharge control unit 21 does not change the output of the vehicle 10 before and after the discharge control even when the output of the engine ENG and the output of the first motor generator MG1 are changed by the discharge control. In this way, the discharge control can be performed while suppressing occurrence of unnatural acceleration or sluggishness that may lead to a decrease in commercial value of the vehicle 10.

In the discharge control, the discharge control unit 21 may increase the discharge amount of the battery BAT and discharge the battery BAT by increasing the frequency at which the vehicle 10 travels in the EV traveling mode. Specifically, in this case, the discharge control unit 21 increases the EV permission electric power by the discharge control. Here, the EV permission electric power is the maximum value of the electric power (for example, the electric power per unit time) that permits the discharge from the battery BAT.

That is, by increasing the EV permission electric power, it is possible to increase the maximum value of the electric power (for example, the electric power per unit time) that can be supplied from the battery BAT to the first motor generator MG1. Therefore, the maximum value of the power that can be output by the first motor generator MG1 can be increased by the electric power of only the battery BAT. As a result, the driving force required for the traveling of the vehicle 10 is easily obtained as the power that can be output by the first motor generator MG1 by the electric power of only the battery BAT. In other words, since a condition for driving the vehicle 10 in the EV traveling mode is easily satisfied, the frequency at which the vehicle 10 travels in the EV traveling mode can be increased.

In the discharge control, the discharge control unit 21 determines a target discharge electric power amount, which is a target value to be discharged before the vehicle 10 reaches the start point of the regenerative section, based on the predicted regenerative electric power amount that can be generated in the regenerative section included in the scheduled traveling route of the vehicle 10. Here, the predicted regenerative electric power amount is a total value of the regenerative electric power that can be generated in the regenerative section when the vehicle 10 travels in the regenerative section. The predicted regenerative electric power amount can be predicted based on the gradient of the regenerative section, the vehicle speed when the vehicle travels in the regenerative section, and the like. In addition, the vehicle speed when the vehicle travels in the regenerative section can be predicted based on the regulated speed of the regenerative section, the congestion situation, and the like.

When the target discharge electric power amount is determined, the discharge control unit 21 determines, as the target discharge electric power amount, a value obtained by subtracting the remaining capacity of the battery BAT, which is a condition for performing the waste electricity control, from the total value of the remaining capacity of the battery BAT and the predicted regenerative electric power amount at that time (that is, the current). In other words, the discharge control unit 21 determines, as the target discharge electric power amount, a difference between the total value of the current remaining capacity of the battery BAT and the predicted regenerative electric power amount and the remaining capacity of the battery BAT, which the condition for performing the waste electricity control.

Here, the remaining capacity of the battery BAT is an electric power amount stored in the battery BAT. The current remaining capacity of the battery BAT can be derived based on the detection signal from the battery sensor described above. In addition, the remaining capacity of the battery BAT (hereinafter, also referred to as “waste electricity start remaining capacity”), which is the condition for performing the waste electricity control, is the remaining capacity of the battery BAT when the SOC of the battery BAT becomes the above-described waste electricity start SOC. The waste electricity start remaining capacity is set in advance in the control device 20.

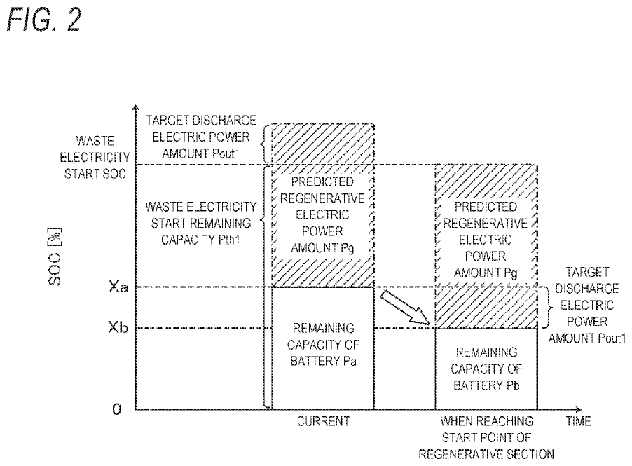

For example, as shown in FIG. 2, it is assumed that the current remaining capacity of the battery BAT is Pa and the current SOC of the battery BAT is Xa [%] (Xa [%]<waste electricity start SOC). In addition, it is assumed that the predicted regenerative electric power amount of the regenerative section included in the scheduled traveling route of the vehicle 10 is Pg. In this case, the total value of the current remaining capacity of the battery BAT and the predicted regenerative electric power amount is Pa+Pg. Then, it is assumed that the total value Pa+Pg is equal to or greater than Pth1 determined as the waste electricity start remaining capacity. In this case, it is assumed that the target discharge electric power amount is Pout, the discharge control unit 21 determines the target discharge electric power amount Pout=Pa+Pg−Pth1=Pout1.

When the target discharge electric power amount is determined in this manner, the discharge control unit 21 performs the discharge control so that an electric power amount corresponding to the determined target discharge electric power amount is discharged from the battery BAT before the vehicle 10 reaches the start point of the regenerative section. Accordingly, as shown in FIG. 2, the discharge control unit 21 can set the remaining capacity of the battery BAT when the vehicle reaches the start point of the regenerative section as Pb. Here, Pb=Pa−Pout1 and Pb+Pg=Pth1. In addition, it is assumed that the SOC when the remaining capacity of the battery BAT is Pb is Xb [%], Xb [%]<Xa [%] is satisfied.

Even if the scheduled traveling route of the vehicle 10 includes the regenerative section, it is also conceivable that the vehicle 10 deviates from the scheduled traveling route (that is, does not travel in the regenerative section) due to some factor. In particular, when the distance from the vehicle 10 to the start point of the regenerative section is sufficiently long, there is a relatively high possibility that the vehicle 10 deviates from the scheduled traveling route before the vehicle 10 reaches the regenerative section.

Therefore, if the discharge control is performed in a state in which the distance from the vehicle 10 to the start point of the regenerative section is sufficiently long, there may occur a situation in which the vehicle 10 does not travel in the regenerative section and the regenerative electric power cannot be obtained even though the battery BAT is discharged by the discharge control. In such a case, it is necessary to stagnate the SOC of the battery BAT due to the lack of regenerative electric power, or to drive the engine ENG and the second motor generator MG2 to recharge the battery BAT. Further, in a case where the engine ENG and the second motor generator MG2 are driven to recharge the battery BAT, the fuel efficiency of the vehicle 10 may be deteriorated.

Therefore, in order to suppress such a situation, the discharge control unit 21 performs the discharge control based on a parameter that changes in accordance with the distance from the vehicle 10 to the start point of the regenerative section. This parameter is, for example, a time required for the vehicle 10 to reach the start point of the regenerative section (hereinafter also referred to as “required arrival time”).

The time required to reach the start point of the regenerative section can be calculated based on the distance from the host vehicle position to the start point of the regenerative section and the vehicle speed. Further, the time required to reach the start point of the regenerative section may be calculated in consideration of the congestion situation from the host vehicle position to the start point of the regenerative section. The vehicle speed. from the host vehicle position to the start point of the regenerative section can be predicted from the regulated speed of the section traveling from the host vehicle position to the start point of the regenerative section, and the like.

In this way, by performing the discharge control based on the time required to reach the start point of the regenerative section, it is possible to perform the discharge control at an appropriate timing in consideration of the distance from the host vehicle position to the start point of the regenerative section, the vehicle speed, the congestion situation, and the like. In the present embodiment, an example will be described in which the parameter that changes in accordance with the distance from the vehicle 10 to the start point of the regenerative section is set as the time required to reach the start point of the regenerative section.

More specifically, when the above-described parameter is set as the required arrival time, the discharge control unit 21 performs (starts) the discharge control in a case where a discharge electric power amount per unit time, which is obtained by dividing the target discharge electric power amount by the required arrival time, becomes equal to or greater than a predetermined first threshold value (for example, Th1 to be described later). As a result, the discharge control unit 21 can perform the discharge control when the timing is appropriate in accordance with the target discharge electric power amount.

That is, by performing the discharge control based on the discharge electric power amount per unit time, it becomes more difficult to perform the discharge control as the time required to reach the regenerative section is longer and the target discharge electric power amount is smaller. Therefore, it is possible to reduce a risk of deterioration in the fuel efficiency due to deviation of the vehicle 10 from the scheduled traveling route. In addition, since it is easier to perform the discharge control as the time required to reach the regenerative section is shorter and the target discharge electric power amount is larger, it is possible to more reliably perform the discharge of the electric power amount corresponding to the target discharge electric power amount before the vehicle 10 reaches the regenerative section such as a downhill.

When the battery BAT is discharged by the discharge control, if a large current is discharged at once, the battery BAT may be deteriorated or a behavior of the vehicle 10 may become unstable. Therefore, in the discharge control, it is preferable that the discharge control unit 21 controls the electric power supplied from the battery BAT to the first motor generator MG1 (that is, the discharge of the battery BAT) based on the discharge electric power amount per unit time.

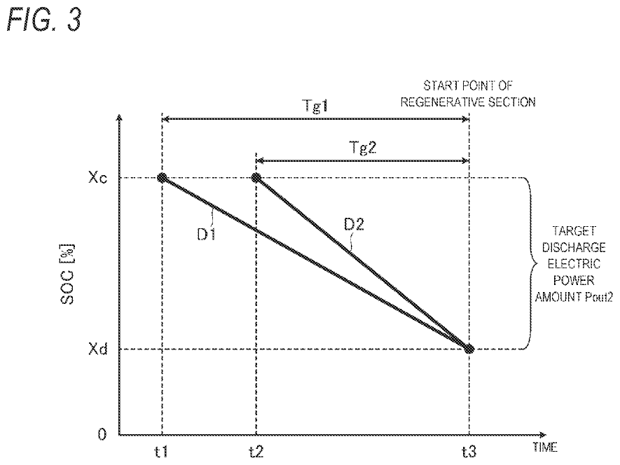

For example, as shown in FIG. 3, it is assumed that at time t1 before the vehicle 10 reaches the start point of the regenerative section, the SOC of the battery BAT is Xc [%], and it is determined to perform the discharge control with the target discharge electric power amount Pout as Pout2. In addition, at the time t1, the time required for the vehicle 10 to reach the start point of the regenerative section is Tg1, and it is predicted that the vehicle 10 reaches the start point of the regenerative section at time t3 when the required arrival time Tg1 has elapsed from the time t1.

In this case, the discharge control unit 21 sets the discharge electric power amount per unit time to Pout2/Tg1, and performs the discharge control to discharge from the battery BAT at this pace. More specifically, in this case, the discharge control unit 21 sets the discharge electric power amount per unit time of the battery BAT requested to the electric power conversion device 11 (hereinafter, also referred to as a “required discharge electric power amount”) to Pout2/Tg1, and instructs the electric power conversion device 11 to discharge from the battery BAT in accordance with the required discharge electric power amount.

Accordingly, as shown by a reference sign D1 in FIG. 3, the discharge control unit 21 can gradually decrease the SOC of the battery BAT in a period from the time t1 to the time t3. Therefore, the battery BAT can be discharged while suppressing the deterioration of the battery BAT and the unstable behavior of the vehicle 10.

It is also conceivable that the discharge of the battery BAT does not proceed as scheduled due to some factor. For example, as shown in FIG. 3, the SOC of the battery BAT may be Xc [%] even at time t2 after the time t1 and before the time t3. It is assumed that, from the time t1 to the time t2, the vehicle 10 is traveling in a traveling mode other than the EV traveling mode.

In such a case, in order to discharge the electric power amount Pout2 before the vehicle 10 reaches the start point of the regenerative section, it is necessary to make the discharge electric power amount per unit time larger than Pout2/Tg1 described above. Therefore, in a case where the discharge electric power amount per unit time is equal to or greater than a second threshold value (for example, Th2 to be described later) greater than the first threshold value described above (that is, the threshold value serving as the condition for performing the discharge control), the discharge control unit 21 increases the frequency at which the vehicle 10 travels in the EV traveling mode by, for example, increasing the EV permission electric power described above.

As a result, the discharge control unit 21 can cause the vehicle 10 to travel in the EV traveling mode from the time t2, and can increase the discharge amount of the battery BAT. Therefore, as shown by a reference sign D2 in FIG. 3, the discharge control unit 21 can quickly decrease the SOC of the battery BAT at a pace of Pout2/Tg2 (here, Pout2/Tg2>Pout2/Tg1) from the time t2 to the time t3.

[Example of Discharge Control Process]

Next, an example of a discharge control process performed by the control device 20 will be described. For example, when the vehicle 10 is in a travelable state (for example, when an ignition power supply of the vehicle 10 is turned on), the control device 20 performs the discharge control process described below.

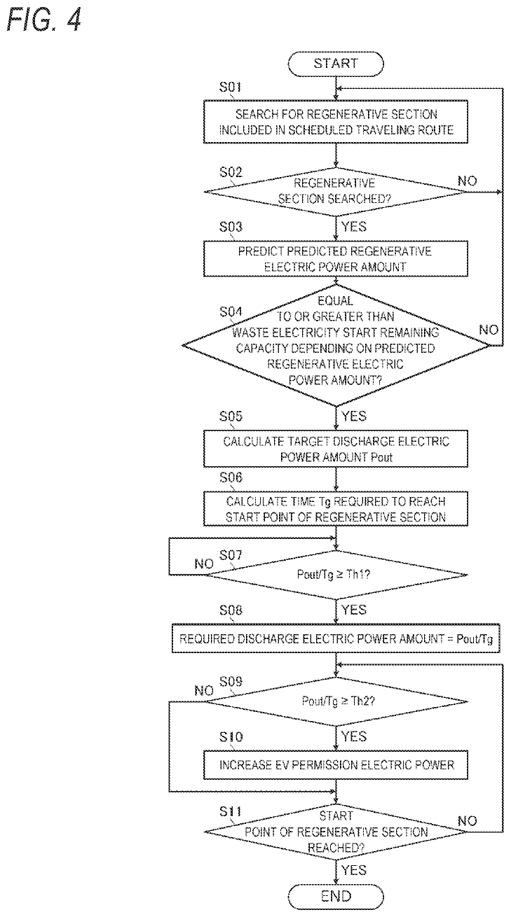

As shown in FIG. 4, the control device 20 searches for the regenerative section included in the scheduled traveling route of the vehicle 10 based on the route information received from the navigation device 13 (step S01). Then, the control device 20 determines whether the regenerative section has been searched through the process of step S01 (step S02). In a case where the regenerative section is not searched (NO in step S02), that is, in a case where the scheduled traveling route of the vehicle 10 does not include the regenerative section, the control device 20 repeats the process of step S01 until the regenerative section is searched.

When the regenerative section is searched (YES in step S02), the control device 20 predicts the predicted regenerative electric power amount of the searched regenerative section (step S03). Then, the control device 20 determines whether the total value of the remaining capacity of the battery BAT and the predicted regenerative electric power amount obtained by the process of step S03 at that time is equal to or greater than the waste electricity start remaining capacity (step S04). In a case where the total value is not equal to or greater than the waste electricity start remaining capacity (NO in step S04), the control device 20 returns to the process of step S01.

In a case where the total value is equal to or greater than the waste electricity start remaining capacity (YES in step S04), the control device 20 determines to perform the discharge control, and calculates the target discharge electric power amount Pout as described above (step S05). Then, the control device 20 calculates the time Tg required to reach the regenerative section based on the distance from the host vehicle position to the start point of the regenerative section, the vehicle speed, and the like (step S06).

Next, the control device 20 determines whether the target discharge electric power amount per unit time obtained by dividing the target discharge electric power amount Pout obtained by the process of step S05 by the required arrival time Tg obtained by the process of step S06, that is, a value obtained by dividing the target discharge electric power amount Pout by the required arrival time Tg (Pout/Tg) becomes equal to or greater than Th1 set in advance as the first threshold value (step S07). When the target discharge electric power amount Pout/the required arrival time Tg is less than Th1 (NO in Step S07), the control device 20 repeats the process of Step S07 until the target discharge electric power amount Pout/the required arrival time Tg becomes equal to or greater than Th1, and waits until the target discharge electric power amount Pout/the required arrival time Tg becomes equal to or greater than Th1.

When the target discharge electric power amount Pout/the required arrival time Tg is equal to or greater than Th1 (YES in step S07), the control device 20 sets the required discharge electric power amount per unit time to the target discharge electric power amount Pout/the required arrival time Tg (step S08), and instructs the electric power conversion device 11 to discharge from the battery BAT at this pace.

Next, the control device 20 determines whether the target discharge electric power amount Pout/the required arrival time Tg is equal to or greater than Th2 set in advance as the second threshold value (step S09). In a case where the target discharge electric power amount Pout/the required arrival time Tg is less than Th2 (NO in step S09), the control device 20 proceeds to the process of step S11 to be described later.

In a case where the target discharge electric power amount Pout/the required arrival time Tg is equal to or greater than Th2 (YES in step S09), the control device 20 increases the EV permission electric power (step S10), and notifies the electric power conversion device 11 of the increased EV permission electric power. Next, the control device 20 determines whether the vehicle 10 has reached the start point of the regenerative section (step S11).

When it is determined that the start point of the regenerative section has not been reached (NO in step S11), the control device 20 returns to the process of step S09. When it is determined that the start point of the regenerative section has been reached (YES in step S11), the control device 20 ends the discharge control process shown in FIG. 4. When the discharge control process ends, the control device 20 returns to the process of step S01 and starts the discharge control process again.

[Specific Example in the Case where Discharge Control is Performed]

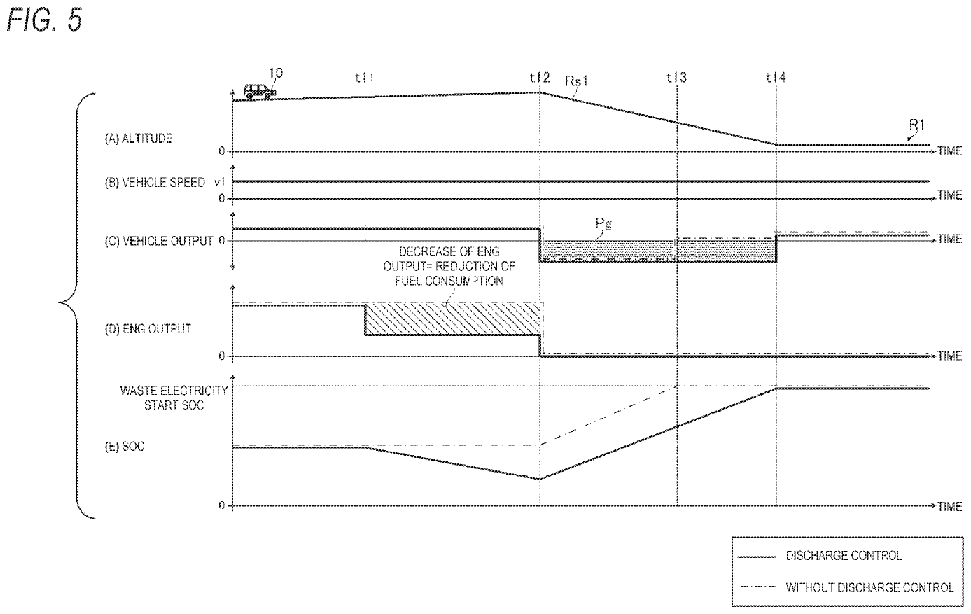

Next, a specific example in the case where the discharge control is performed by the control device 20 will be described. In FIG. 5, the vehicle 10 is traveling on a route R1 at a constant vehicle speed v1 (for example, 10 [km/h]) (see (A) and (B) in FIG. 5). Here, the route R1 is a route predicted as a scheduled traveling route of the vehicle 10, and includes a regenerative section Rs1. In addition, in the regenerative section Rs1, it is predicted that the predicted regenerative electric power amount Pg can be generated.

In the example shown in FIG. 5, the control device 20 performs the discharge control from the time t11 before the vehicle 10 reaches the start point of the regenerative section Rs1. Here, the time t11 is time at which the value of Pout/Tg obtained by dividing the target discharge electric power amount Pout determined based on the predicted regenerative electric power amount Pg by the required arrival time Tg is Th1 (that is, the first threshold value).

When the discharge control is performed, the control device 20 reduces the output of the engine ENG (shown as “ENG output” in FIG. 5) while maintaining the output of the vehicle 10 (shown as “vehicle output” in FIG. 5) from a state before the discharge control is performed (that is, the state before the time t11) (see (C) and (D) in FIG. 5). Further, the output of the first motor generator MG1 is increased by increasing the electric power supplied from the battery BAT to the first motor generator MG1 by an amount by which the output of the engine ENG is decreased.

Accordingly, as shown in FIG. 5, the control device 20 can reduce the fuel consumption of the engine ENG in a period from time t11 to time t12 at which the vehicle 10 reaches the start point of the regenerative section Rs1, and can improve the fuel efficiency of the vehicle 10. Further, the control device 20 can perform the discharge of the battery BAT during the period from the time t11 to the time t12, and can reduce the SOC of the battery BAT until the time t12 (see (E) in FIG. 5).

More specifically, the control device 20 can cause the battery BAT to be discharged until the time t12 such that even if the predicted regenerative electric power amount Pg, which can be generated in the regenerative section Rs1, is supplied to the battery BAT, the remaining capacity of the battery BAT does not reach the waste electricity start remaining capacity Pth1. Therefore, even when the regenerative electric power corresponding to the predicted regenerative electric power amount Pg is generated during a period from the time t12 to time t14 at which the vehicle 10 passes through the regenerative section Rs1, the vehicle 10 makes it possible to supply the regenerative electric power to the battery BAT without wasting electric power (that is, charge the battery BAT), and to effective use the regenerative electric power.

On the other hand, if the above-described discharge control is not performed, as indicated by an alternate long and short dash line in FIG. 5, the same state as before the time t11 is maintained even in the period from the time t11 to the time t12. That is, in this case, even in the period from the time t11 to the time t12, the same output of the engine ENG as that before the time t11 is maintained, so that it is not possible to reduce the fuel consumption of the engine ENG in this period.

Further, in the case where the above-described discharge control is not performed, the discharge of the battery BAT that enables the predicted regenerative electric power amount Pg to be supplied to the battery BAT is not performed until the time t12, so that the SOC of the battery BAT reaches the waste electricity start SOC at time t13 during which the vehicle 10 passes through the regenerative section Rs1, and the waste electricity is started. Therefore, in this case, the regenerative electric power generated during a period from the time t13 to the time t14 cannot be effectively used.

As described above, according to the control device 20, it is possible to appropriately control the discharge of the battery BAT based on the scheduled traveling route of the vehicle 10.

In the example described above, the example in which the control device 20 controls the discharge of the battery BAT based on the scheduled traveling route of the vehicle 10 has been described, but the present invention is not limited thereto. The control device 20 may control the charge of the battery BAT based on the scheduled traveling route of the vehicle 10.

Specifically, in this case, as shown in FIG. 1, the control device 20 includes a charge control unit 22 as a functional unit realized by the processor executing a program stored in a storage device of the control device 20.

In the case where a discharge section in which the electric power of the battery BAT is supplied to the first motor generator MG1 is included in the scheduled traveling route of the vehicle 10, the charge control unit 22 performs the charge control of increasing the charge amount of the battery BAT as compared with the case where the discharge section is not included in the scheduled traveling route.

In the charge control, for example, when the vehicle 10 is traveling in the hybrid traveling mode, the charge control unit 22 increases the output of the engine ENG to cause the second motor generator MG2 to generate electric power larger than the electric power consumed by the first motor generator MG1. Accordingly, it is possible to charge the battery BAT by the electric power generated by the second motor generator MG2 while ensuring the electric power consumed by the first motor generator MG1 and maintaining the output of the vehicle 10.

In the charge control, it is preferable that the charge control unit 22 increases the output of the engine ENG within a range in which a rotational speed of the engine ENG does not exceed a predetermined value. Here, the predetermined value is the number of revolutions of the engine ENG determined from a NV (Noise, Vibration) viewpoint. As a result, even when the charge control is performed, the charge control unit 22 can suppress a decrease in the commercial value of the vehicle 10 from the NV viewpoint.

In the charge control, the charge control unit 22 determines a target charge electric power amount, which is a target value to be charged before the vehicle 10 reaches a start point of the discharge section, based on a predicted discharge electric power amount that can be discharged in the discharge section included in the scheduled traveling route of the vehicle 10. Here, the predicted discharge electric power amount is a total value of the electric power of the battery BAT that can be supplied to the first motor generator MG1 in the discharge section when the vehicle 10 travels in the discharge section. The predicted discharge electric power amount can be predicted based on a gradient of the discharge section, the vehicle speed when the vehicle travels in the discharge section, and the like. The vehicle speed when the vehicle travels in the discharge section can be predicted based on a regulated speed of the discharge section, the congestion situation, and the like. In addition, the predicted discharge electric power amount may also include electric power of the battery BAT that can be supplied to various auxiliary machines included in the vehicle 10 in the discharge section.

When determining the target charge electric power amount, the charge control unit 22 determines, as the target charge electric power amount, a value obtained by subtracting the remaining capacity of the battery BAT at that time from the total value of the remaining capacity of the battery BAT (hereinafter, also referred to as “assist lower limit remaining capacity”) and the predicted discharge electric power amount, which are conditions for enabling the electric power of the battery BAT to be supplied to the first motor generator MG1. The assist lower limit remaining capacity is set in advance in the control device 20.

For example, when the current remaining capacity of the battery BAT is Pc, the predicted discharge electric power amount is Pd, an assist lower limit remaining capacity is Pth2, and the target charge electric power amount is Pin, the charge control unit 22 determines the target charge electric power amount Pin=the predicted discharge electric power amount Pd+the assist lower limit remaining capacity Pth2−the current remaining capacity Pc of the battery BAT. As a result, it is possible to perform the charge control in which an amount of the electric power to be supplied to the first motor generator MG1 when the vehicle passes through the discharge section can be secured in the battery BAT.

Similarly to the discharge control by the discharge control unit 21, the charge control unit 22 performs the charge control based on the parameter that changes in accordance with the distance from the vehicle 10 to the start point of the discharge section in order to perform the charge control from an appropriate timing. This parameter is, for example, a

required arrival time required for the vehicle 10 to reach the start point of the discharge section. Accordingly, it is possible to perform the charge control at an appropriate timing in consideration of the distance from the host vehicle position to the start point of the discharge section, the vehicle speed, the congestion situation, and the like.

[Specific Example in the Case where Charge Control is Performed]

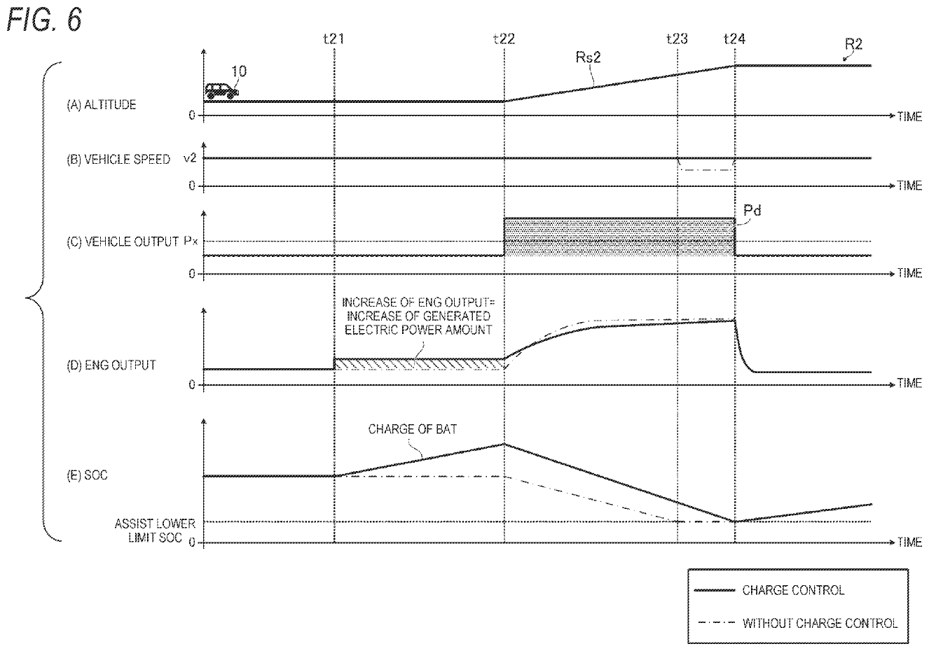

Next, a specific example in the case where the charge control is performed by the control device 20 will be described. In an example shown in FIG. 6, the vehicle 10 is traveling on a route R2 at a constant vehicle speed v2 (for example, 100 [km/h]) in the hybrid traveling mode (see (A) and (B) in FIG. 6). The route R2 is a route predicted as a scheduled traveling route of the vehicle 10, and includes a discharge section Rs2.

The discharge section Rs2 is a section in which the vehicle speed v2 cannot be maintained at the maximum value (“Px” in FIG. 6) of the output of the vehicle 10 obtained by supplying only the electric power generated by the second motor generator MG2 to the first motor generator MG1. Therefore, in order to maintain the vehicle speed v2 in the discharge section Rs2, the electric power of the battery BAT needs to be supplied to the first motor generator MG1 in addition to the electric power generated by the second motor generator MG2, and the predicted discharge electric power amount of the discharge section Rs2 due to this is predicted to be Pd. Then, it is assumed that a value obtained by subtracting the predicted discharge electric power amount Pd of the discharge section Rs2 from the current remaining capacity of the battery BAT becomes equal to or less than the assist lower limit remaining capacity Pth2.

In this case, the control device 20 performs the charge control from time t21 before the vehicle 10 reaches the start point of the discharge section Rs2. Here, the time t21 is time at which a value of Pin/Tg obtained by dividing the target charge electric power amount Pin determined based on the predicted discharge electric power amount Pd by the required arrival time Tg is equal to a predetermined threshold value (for example, Th1).

When the charge control is performed, the control device 20 increases the output of the engine ENG (shown as “ENG output” in FIG. 6) while maintaining the output of the vehicle 10 (shown as “vehicle output” in FIG. 6) from a state before the charge control is performed (that is, the state before the time t21) (see (C) and (D) in FIG. 6), As a result, since the electric power generated by the second motor generator MG2 increases, the control device 20 supplies the increased amount of electric power to the battery BAT to charge the battery BAT.

Therefore, as shown in FIG. 6, the control device 20 can perform the charge of the battery BAT during a period from the time t21 to time t22 at which the vehicle 10 reaches the start point of the discharge section Rs2, and can increase the SOC of the battery BAT until the time t22 (see (E) in FIG. 6), More specifically, the control device 20 can set the battery BAT at the SOC that does not become an assist lower limit SOC even when the electric power corresponding to the predicted discharge electric power amount Pd is supplied to the battery BAT in the discharge section Rs2 before the time t22.

Therefore, during the period from the time t22 to time t24 at which the vehicle 10 passes through the discharge section Rs2, the control device 20 makes it possible to supply the electric power of the battery BAT to the first motor generator MG1 in addition to the electric power generated by the second motor generator MG2, and maintain the vehicle speed v2 in the discharge section Rs2. Accordingly, it is possible to suppress a decrease in the vehicle speed because the electric power of the battery BAT is insufficient in the discharge section Rs2 and the output of the vehicle 10 cannot be maintained.

On the other hand, if the above-described charge control is not performed, as indicated by an alternate long and short dash line in FIG. 6, the same state as before the time 121 is maintained even in the period from the time t21 to the time t22. That is, in this case, even in the period from the time t21 to the time t22, the same output of the engine ENG as that before the time t21 is maintained, so that the second motor generator MG2 cannot generate electric power for charging the battery BAT.

Therefore, even if the electric power corresponding to the predicted discharge electric power amount Pd is supplied to the battery BAT in the discharge section Rs2 before the time t22, the battery BAT cannot be set to the SOC that does not become the assist lower limit SOC. Therefore, at time t23 at which the vehicle 10 passes through the discharge section Rs2, the SOC of the battery BAT reaches the assist lower limit SOC, and the electric power of the battery BAT cannot be supplied to the first motor generator MG1. Accordingly, during the period from the time t23 to the time t24, the output of the vehicle 10 decreases, and the vehicle speed v2 cannot be maintained.

As described above, according to the control device 20, it is possible to appropriately control the charge of the battery BAT based on the scheduled traveling route of the vehicle 10.

Although the embodiment of the present invention has been described above, the present invention is not limited to the embodiment described above, and modifications, improvements, and the like can be made as appropriate.

For example, although the example in which the control device 20 includes both the discharge control unit 21 and the charge control unit 22 has been described in the embodiment described above, the present invention is not limited thereto, and only one of the discharge control unit 21 and the charge control unit 22 may be provided.

The example in which the second threshold value, which is the condition for increasing the EV permission electric power (that is, the condition for increasing the frequency of traveling in the EV traveling mode), is larger than the first threshold value, which is the condition for performing (starting) the discharge control, has been described in the embodiment described above, but the present invention is not limited thereto, and the second threshold value may be a value equal to the first threshold value. That is, the EV permission electric power may be increased at the same time to increase the frequency of traveling in the EV traveling mode while the discharge amount from the battery BAT in the hybrid traveling mode or the like is increased. Also in this case, it is possible to appropriately discharge the battery BAT based on the scheduled traveling route of the vehicle 10.

In the above-described embodiment, the navigation device 13 is provided in the vehicle 10, but the present invention is not limited thereto. The navigation device 13 may be provided so as to be communicable with the control device 20, and may be realized by a smart phone or the like that can notify the control device 20 of the scheduled traveling route of the vehicle 10 and the host vehicle position. In addition, some or all of the functions of the navigation device 13 may be realized by a server device outside the vehicle 10.

The example in which the vehicle according to the present invention is a hybrid electrical vehicle has been described in the embodiment described above, but the present invention is not limited thereto. For example, the vehicle according to the present invention may be a fuel cell vehicle. That is, the vehicle according to the present invention may be a vehicle including a generator that generates electric power using a chemical reaction of a fuel cell instead of the engine ENG and the second motor generator MG2 described above.

The example in which the parameter that changes in accordance with the distance from the vehicle 10 to the start point of the regenerative section or the discharge section is set as the time required to reach the start point has been described in the embodiment described above, but the present invention is not limited thereto, and for example, this parameter may be set as the distance itself to the start point.

In the present specification, at least the following matters are described. Corresponding constituent elements or the like in the above embodiment are shown in parentheses, and the present invention is not limited thereto.

(1) A control device (control device 20) of a vehicle (vehicle 10), the vehicle including:

a power storage device (battery BAT); and

an electric motor (first motor generator MG1) connected to a drive wheel (drive wheel DW), driven by being supplied with electric power of the power storage device, and configured to supply regenerative electric power generated by a regenerative operation to the power storage device,

the control device including:

a discharge control unit (discharge control unit 21) configured to, in a case where a regenerative section (regenerative section Rs1) in which the electric motor is able to perform a regenerative operation is included in a scheduled traveling route (route R1) of the vehicle. perform a discharge control for increasing a discharge amount of the power storage device as compared with a case where the regenerative section is not included in the scheduled traveling route,

wherein the discharge control unit is configured to,
determine a target discharge electric power amount, which is a target value to be discharged before the vehicle reaches a start point of the regenerative section, based on a predicted regenerative electric power amount (predicted regenerative electric power amount Pg) that is capable of being generated in the regenerative section, and
perform the discharge control based on the target discharge electric power amount and a parameter that changes in accordance with a distance from the vehicle to the start point.

According to (1), the target discharge electric power amount, which is the target value to be discharged before the vehicle reaches the start point of the regenerative section, is determined based on the predicted regenerative electric power amount that is capable of being generated in the regenerative section, and the discharge control is performed based on the target discharge electric power amount and the parameter that changes in accordance with the distance from the vehicle to the start point of the regenerative section, so that it is possible to appropriately control the discharge of the power storage device based on the scheduled traveling route of the vehicle.

(2) The control device of a vehicle according to (1),

wherein the discharge control unit performs the discharge control in a case where a discharge electric power amount per unit amount obtained by dividing the target discharge electric power amount by the parameter is equal to or greater than a first threshold value.

According to (2), the discharge control is performed in the case where the discharge electric power amount per unit amount becomes equal to or greater than the first threshold value, so that the discharge control can be performed in a case where the timing is appropriate in accordance with the target discharge electric power amount.

(3) The control device of a vehicle according to (2),

wherein the discharge control unit controls electric power supplied from the power storage device to the electric motor based on the discharge electric power amount per unit amount in the discharge control.

According to (3), the electric power supplied from the power storage device to the first motor generator is controlled based on the discharge electric power amount per unit amount, so that the power storage device can be discharged while suppressing a deterioration of the power storage device and an unstable behavior of the vehicle by gradually performing the discharge of the power storage device.

(4) The control device of a vehicle according to (2) or (3),

wherein the vehicle further includes an internal combustion engine (engine ENG), and is able to travel by driving of the drive wheel by power from at least one of the internal combustion engine and the electric motor, and

wherein the discharge control unit increases a frequency of driving the drive wheel by power of only the electric motor to cause the vehicle to travel in the discharge control in a case where the discharge electric power amount per unit amount is equal to or greater than a second threshold value that is equal to greater than the first threshold value.

According to (4), in the case where the discharge electric power amount per unit amount is equal to or greater than the second threshold value that is equal to or greater than the first threshold value, in the discharge control, the frequency of driving the drive wheel by the power of only the first motor generator to cause the vehicle to travel is increased, so that the power storage device can be quickly discharged.

(5) The control device of a vehicle according to any one of (1) to (4),

wherein the vehicle is able to perform waste electricity that consumes the regenerative electric power without supplying the regenerative electric power to the power storage device, and

wherein the discharge control unit determines, as the target discharge electric power amount, a difference between a total value of a current remaining capacity of the power storage device and the predicted regenerative electric power amount and the remaining capacity of the power storage device, which is a condition for performing the waste electricity.

According to (5), the difference between the total value of the current remaining capacity of the power storage device and the predicted regenerative electric power amount and the remaining capacity of the power storage device, which is the condition for performing the waste electricity, is determined as the target discharge electric power amount, so that even when the regenerative electric power corresponding to the predicted regenerative electric power amount is generated, the regenerative electric power can be supplied to the power storage device without wasting the regenerative electric power (that is, charge the power storage device), and the regenerative electric power can be effectively used.

(6) The control device of a vehicle according to any one of (1) to (5),

wherein the parameter is a time required for the vehicle to reach the start point.

According to (6), it is possible to perform the discharge control at an appropriate timing in consideration of the distance from the vehicle to the start point of the regenerative section, a vehicle speed, a congestion situation, and the like.

(7) A control device (control device 20) of a vehicle (vehicle 10), the vehicle including:

a power storage device (battery BAT);

an electric motor (first motor generator MG1) connected to a drive wheel (drive wheel DW) and driven by being supplied with electric power of the power storage device; and

a generator (second motor generator MG2) configured to generate electric power and supplying the generated electric power to the power storage device,

the control device including:

a charge control unit (charge control unit 22) configured to, in a case where a discharge segment (discharge section Rs2) in which the electric power of the power storage device is supplied to the electric motor is included in a scheduled traveling route (route R2) of the vehicle, perform a charge control for increasing a charge amount of the power storage device as compared with a case where the discharge section is not included in the scheduled traveling route,

wherein the charge control unit is configured to,
determine a target charge electric power amount, which is a target value to be charged before the vehicle reaches a start point of the discharge section based on a predicted discharge electric power amount (predicted discharge electric power amount Pd) that is capable of being discharged in the discharge section, and
perform the charge control based on the target charge electric power amount and a parameter that changes in accordance with a distance from the vehicle to the start point.

According to (7), the target charge electric power amount, which is the target value to be charged before the vehicle reaches the start point of the discharge section, is determined based on the predicted discharge electric power amount that is capable of being discharged in the discharge section, and the charge control is performed based on the target charge electric power amount and the parameter that changes in accordance with the distance from the vehicle to the start point of the discharge section, so that it is possible to appropriately control the charge of the power storage device based on the scheduled traveling route of the vehicle.

What is claimed is:

1. A control device of a vehicle, the vehicle including:
a power storage device; and
an electric motor connected to a drive wheel, driven by being supplied with electric power of the power storage device, and configured to supply regenerative electric power generated by a regenerative operation to the power storage device,
the control device comprising:
a discharge control unit configured to, in a case where a regenerative section in which the electric motor is able to perform a regenerative operation is included in a scheduled traveling route of the vehicle, perform a discharge control for increasing a discharge amount of the power storage device as compared with a case where the regenerative section is not included in the scheduled traveling route,
wherein the discharge control unit is configured to,
determine a target discharge electric power amount, which is a target value to be discharged before the vehicle reaches a start point of the regenerative section, based on a predicted regenerative electric power amount that is capable of being generated in the regenerative section, and
perform the discharge control based on the target discharge electric power amount and a parameter that changes in accordance with a distance from the vehicle to the start point.

2. The control device of a vehicle according to claim 1,
wherein the discharge control unit performs the discharge control in a case where a discharge electric power amount per unit amount obtained by dividing the target discharge electric power amount by the parameter is equal to or greater than a first threshold value.

3. The control device of a vehicle according to claim 2,
wherein the discharge control unit controls electric power supplied from the power storage device to the electric motor based on the discharge electric power amount per unit amount in the discharge control.

4. The control device of a vehicle according to claim 2,
wherein the vehicle further includes an internal combustion engine, and is able to travel by driving of the drive wheel by power from at least one of the internal combustion engine and the electric motor, and
wherein the discharge control unit increases a frequency of driving the drive wheel by power of only the electric motor to cause the vehicle to travel in the discharge control in a case where the discharge electric power amount per unit amount is equal to or greater than a second threshold value that is equal to greater than the first threshold value.

5. The control device of a vehicle according to claim 1,
wherein the vehicle is able to perform waste electricity that consumes the regenerative electric power without supplying the regenerative electric power to the power storage device, and
wherein the discharge control unit determines, as the target discharge electric power amount, a difference between a total value of a current remaining capacity of the power storage device and the predicted regenerative electric power amount and the remaining capacity of the power storage device, which is a condition for performing the waste electricity.

6. The control device of a vehicle according to claim 1,
wherein the parameter is a time required for the vehicle to reach the start point.

7. A control device of a vehicle, the vehicle including:
a power storage device;
an electric motor connected to a drive wheel and driven by being supplied with electric power of the power storage device; and
a generator configured to generate electric power and supplying the generated electric power to the power storage device,
the control device comprising:
a charge control unit configured to, in a case where a discharge segment in which the electric power of the power storage device is supplied to the electric motor is included in a scheduled traveling route of the vehicle, perform a charge control for increasing a charge amount of the power storage device as compared with a case where the discharge section is not included in the scheduled traveling route,
wherein the charge control unit is configured to,
determine a target charge electric power amount, which is a target value to be charged before the vehicle reaches a start point of the discharge section based on a predicted discharge electric power amount that is capable of being discharged in the discharge section, and
perform the charge control based on the target charge electric power amount and a parameter that changes in accordance with a distance from the vehicle to the start point.
